(19) United States
(12) Patent Application Publication
(10) Pub. No.: US 2026/0051534 A1
(43) Pub. Date: Feb. 19, 2026

(54) GLASS-CERAMICS SOLID ELECTROLYTE AND LITHIUM-ION BATTERY

(71) Applicant: IDEMITSU KOSAN CO.,LTD., Tokyo (JP)

(72) Inventors: Naoya MASUDA, Tokyo (JP); Kota TERAI, Tokyo (JP)

(73) Assignee: IDEMITSU KOSAN CO.,LTD., Tokyo (JP)

(21) Appl. No.: 18/996,175

(22) PCT Filed: Jul. 31, 2023
(86) PCT No.: PCT/JP2023/027919

§ 371 Date: Jan. 17, 2025

(30) Foreign Application Priority Data
Aug. 3, 2022 (JP) 2022-123820

(51) Int. Cl. H01M 10/0562; H01M 10/0525

(52) U.S. Cl. CPC H01M 10/0562; H01M 10/0525; H01M 2300/008

(57) ABSTRACT

A glass-ceramic solid electrolyte comprising lithium, phosphorus, sulfur and halogen as constituent elements, wherein a molar ratio (Li/P) of the lithium (Li) to the phosphorus (P) is 2.0 to 5.3, a molar ratio (S/P) of the sulfur(S) to the phosphorus (P) is 2.0 to 4.5, and a molar ratio (X/P) of the halogen (X) to the phosphorus (P) is 0.1 to 2.3, and the glass-ceramic solid electrolyte has a peak A at position of 2θ=20±1° in powder X-ray diffraction using CuKα ray, and has no peak B at a position of 2θ=23.6±1°, or has the peak B in the powder X-ray diffraction, when the glass-ceramic solid electrolyte has the peak B, a peak intensity ratio (I_{B}/I_{A}) of a peak intensity (I_{B}) of the peak B to a peak intensity (I_{A}) of the peak A is less than 0.050, and the glass-ceramic solid electrolyte has a crystallite size of 5 to 20 nm.

### TECHNICAL FIELD

The present disclosure relates to a glass-ceramic solid electrolyte and a lithium-ion battery.

### BACKGROUND ART

With rapid spread of information-related equipment or communication equipment such as a personal computer, a video camera, and a mobile phone in recent years, the development of a battery used as a power source thereof has been considered to be important. Among these batteries, a lithium-ion battery has attracted attention from the viewpoint of the energy-density being high.

Currently commercially available lithium-ion batteries use an electrolyte containing a flammable organic solvent. Therefore, attachment of a safety device that suppresses an increase in temperature at the time of short circuit, and improvement in structure and material in order to avoid occurrence of short circuit are required. In contrast, in the lithium ion battery formed into all-solid-state battery by using a solid electrolyte in place of the liquid electrolyte, it is considered that the lithium ion battery does not use the flammable organic solvent, so that the safety device can be simplified, and the lithium ion battery is excellent in a production cost or productivity.

As such a solid electrolyte used for lithium-ion battery, a sulfide solid electrolyte has been known (see, for example, Patent Document 1).

In order to increase the performance of a lithium-ion battery, it is essential to increase the filling rate (consolidation characteristic) of a solid electrolyte powder. In order to increase the filling rate, it is effective to mechanically soften a solid electrolyte (to make it easier to deform by compression).

In a lithium-ion conductive sulfide solid electrolyte, it is known that a Li₃PS₄ glass has a higher filling rate. However, a Li₃PS₄ glass had low ionic conductivity less than 1 mS/cm.

### RELATED ART DOCUMENTS

### Patent Documents

[Patent Document 1] JP 2019-506699 A

### SUMMARY OF THE INVENTION

It is an object of the present disclosure to provide a glass-ceramic solid electrolyte having a higher filling rate and a higher ionic conductivity.

According to the present disclosure, the following glass-ceramic solid electrolyte and so on are provided.
1. A glass-ceramic solid electrolyte comprising lithium, phosphorus, sulfur and halogen as constituent elements, wherein
   a molar ratio (Li/P) of the lithium (Li) to the phosphorus (P) is 2.0 to 5.3,
   a molar ratio (S/P) of the sulfur(S) to the phosphorus (P) is 2.0 to 4.5, and
   a molar ratio (X/P) of the halogen (X) to the phosphorus (P) is 0.1 to 2.3, and
   the glass-ceramic solid electrolyte has a peak A at position of 2θ=20±1° in powder X-ray diffraction using CuKα ray, and has no peak B at a position of 2θ=23.6±1°, or has the peak B in the powder X-ray diffraction,
   when the glass-ceramic solid electrolyte has the peak B, a peak intensity ratio (I_{B}/I_{A}) of a peak intensity (I_{B}) of the peak B to a peak intensity (I_{A}) of the peak A is less than 0.050, and
   the glass-ceramic solid electrolyte has a crystallite size of 5 to 20 nm.
2. The glass-ceramic solid electrolyte according to 1, wherein the peak intensity ratio (I_{B}/I_{A}) is 0.
3. The glass-ceramic solid electrolyte according to 1 or 2, which has peaks derived from lithium halide in the powder X-ray diffraction using CuKα ray.
4. The glass-ceramic solid electrolyte according to 3, wherein a crystallite size of the lithium halide calculated from the peak having the maximum intensity among the peaks derived from the lithium halide is 5 to 100 nm.
5. The glass-ceramic solid electrolyte according to any one of 1 to 4, wherein a relative density of a green compact pressurized at 400 MPa has 90% or more.
6. The glass-ceramic solid electrolyte according to any one of 1 to 5, having a true density of 2.0 to 3.0 g/cm³.
7. The glass-ceramic solid electrolyte according to any one of 1 to 6, wherein the molar ratio (X/P) is greater than 0.86.
8. The glass-ceramic solid electrolyte according to any one of 1 to 7, comprising two or more halogens as the halogen.
9. The glass-ceramic solid electrolyte according to 8, wherein the halogen comprises iodine and bromine.
10. The glass-ceramic solid electrolyte according to 9, wherein
   a molar ratio (l/P) of the iodine (I) to the phosphorus (P) is 0.0<(I/P)<1.8, and
   a molar ratio (Br/P) of the bromine (Br) to the phosphorus (P) is 0.0<(Br/P)<1.5.
11. The glass-ceramic solid electrolyte according to any one of 1 to 10, having an ionic conductivity of 1 mS/cm or more.
12. A lithium-ion battery comprising the glass-ceramic solid electrolyte according to any one of 1 to 11.

According to the present disclosure, a glass-ceramic solid electrolyte having a high filling rate and a high ionic conductivity can be provided.

### BRIEF DESCRIPTION OF THE DRAWINGS

FIG. 1 is a schematic diagram for explaining a pellet density measuring apparatus.

FIG. 2 is an X-ray diffraction patterns of a glass-ceramic solid electrolyte prepared in

### Examples 1 to 4.

FIG. 3 is an X-ray diffraction patterns of a glass-ceramic solid electrolyte prepared in Examples 5 to 8.

FIG. 4 is an X-ray diffraction patterns of a glass-ceramic solid electrolyte prepared in Examples 9 to 12.

FIG. 5 is an X-ray diffraction patterns of a glass-ceramic solid electrolyte prepared in Examples 13 to 16.

FIG. 6 is an X-ray diffraction patterns of a glass-ceramic solid electrolyte prepared in Examples 17 to 21.

FIG. 7 is an X-ray diffraction patterns of a glass-ceramic solid electrolyte prepared in Comparative Examples 1 to 5.

FIG. 8 is an X-ray diffraction patterns of a glass-ceramic solid electrolyte prepared in Comparative Examples 6 to 11.

### MODE FOR CARRYING OUT THE INVENTION

Hereinafter, the embodiment of the present disclosure (hereinafter sometimes referred to as “the present embodiment”) will be described. In the present specification, numerical values of the upper limit and the lower limit of numerical values that are accompanied with “or more”, “or less”, and “to” can be arbitrarily combined. Numerical values described in Examples can also be used as those of the upper limit and the lower limit.

A glass-ceramic solid electrolyte according to one aspect of the present disclosure contains lithium (Li), phosphorus (P), sulfur(S), and halogen (X) as constituent elements. The molar ratios ((Li, S, or X)/P) of the constituent elements to phosphorus satisfies the following ranges:

$$Li / P = 2. to 5.3$$

$$S / P = 2. to 4.5$$

$$X / P = 0.1 to 2.3$$

In addition, the glass solid electrolyte shows peaks derived from lithium bromide in powder X-ray diffraction using CuKα ray.

In addition, the glass-ceramic solid electrolyte of the present aspect satisfies the following requirements A to C.
A. In powder X-ray diffraction using CuKα ray, the glass-ceramic solid electrolyte has a peak A at the position of 2θ=20±1°.
B. In powder X-ray diffraction, the glass-ceramic solid electrolyte has no peak B at the position of 2θ=23.6±1°, or has the peak B, when the glass-ceramic solid electrolyte has the peak B, the peak intensity ratio (I_{B}/I_{A}) of the peak intensity (I_{B}) of the peak B and the peak intensity (I_{A}) of the peak A is smaller than 0.05.
C. The crystallite size of the glass-ceramic solid electrolyte calculated by Scherrer's formula based on the peak A is 5 to 20 nm.

The glass-ceramic solid electrolyte according to this aspect of the present disclosure has a filling rate equal or higher than that those of a conventional glass solid electrolyte, and a higher ionic conductivity.

The glass-ceramic solid electrolyte in the present disclosure is means a solid electrolyte that has peaks derived from the solid electrolyte observed in an X-ray diffraction pattern obtained by powder X-ray diffraction (XRD) measurement, and may or may not have a peak derived from the raw material of the solid electrolyte. That is, the glass-ceramic solid electrolyte contains a crystalline structure derived from the solid electrolyte, a part of which may be a the crystalline structure derived from the solid electrolyte, or all of which may be a the crystalline structure derived from the solid electrolyte. The glass-ceramic solid electrolyte may contain an amorphous component (also referred to as a “glass component”) in a part thereof as long as it has the above-described X-ray diffraction pattern. Incidentally, the crystalline solid electrolyte includes so-called glass ceramics obtained by heating an amorphous solid electrolyte (glass components) to a crystallization temperature or higher.

In the glass-ceramic solid electrolyte of the present embodiment, the molar ratio (Li/P) of the lithium (Li) to the phosphorus (P) is preferably 3.0 to 5.25, and more preferably 3.5 to 5.20. The molar ratio (S/P) of the sulfur(S) to the phosphorus (P) is preferably 3.0 to 4.4, and more preferably 3.5 to 4.3. The molar ratio (X/P) of the halogen (X) to the phosphorus (P) is preferably greater than 0.75, and more preferably greater than 0.86.

In the glass-ceramic solid electrolyte of the present embodiment, as the halogen (X), one or more selected from the group consisting of a fluorine (F), a chlorine (CI), a bromine (Br), and an iodine (I) are preferably contained, and more preferably Br or I is contained. As the halogen (X), bromine (Br) and iodine (I) are preferably contained.

Preferably, the molar ratio (I/P) of the iodine (I) to the phosphorus (P) is 0.0 to 1.8, and the molar ratio (Br/P) of the bromine (Br) to the phosphorus (P) is 0.0 to 1.5.

The type and molar ratio of the constituent elements of the glass-ceramic solid electrolyte can be confirmed by, for example, an ICP emission spectrometer.

The molar ratios of the constituent elements of the glass-ceramic solid electrolyte can be adjusted by varying blending amounts of raw materials. The molar ratios of the constituent elements in the raw material are substantially equal to the molar ratio of the constituent elements of the obtained glass-ceramic solid electrolyte.

In the glass-ceramic solid electrolyte of the present embodiment, it is preferable that the molar ratio (Li/P) of the lithium (Li) to the phosphorus (P) and the molar ratio (X/P) of the halogen (X) to the phosphorus (P) satisfy the following relational formula (1).

$$Li / P = 3 \pm α + X / P \qquad ( 1 )$$

(In the formula, α is 0 to 0.5.)

When the formula (1) is satisfied, since the generation amount of PS₄³⁻ tetrahedral structure, which is the main skeleton of the glass-ceramic solid electrolyte, increases, the effect of reducing the amount of hydrogen sulfide generated in a low dew point environment can be obtained. In addition, since the generation amount of P₂S₆⁴⁻ structure and P₂S₇⁴⁻ structure that are larger and stiffer than PS₄³⁻ structure decreases, an effect of increasing the softness of the glass-ceramic solid electrolyte can be obtained.

The α of the formula (1) may be 0 to 0.3, 0 to 0.1, or 0.

The glass-ceramic solid electrolyte of the present embodiment has a peak A at a position of 2θ=20±1° in powder X-ray diffraction using CuKα ray, and the crystallite size of the glass-ceramic solid electrolyte calculated based on the peak A is 1 to 20 nm. The crystallite size of the glass-ceramic solid electrolyte calculated based on the peak A is preferably 2 to 18 nm. The small crystallite size allows compress the glass-ceramic solid electrolyte without breaking of the crystallite when compressed. In addition, since the crystallite size is not too small, the ionic conductivity of the glass-ceramic solid electrolyte can be maintained to be high. Thus, the glass-ceramic solid electrolyte of the present embodiment can achieve both a higher filling rate and a higher ionic conductivity at the same time.

In general, the diffraction peak of powder X-ray diffraction measurement has a width, and a peak width at a half height of the peak height obtained by subtracting the background therefrom is referred to as the half-value width. It is known that there is a correlation between the half-value width and the crystallite size. When the crystallite size is large, the crystallinity becomes high, and since the repeating regularity of the crystalline structure becomes high, the intensity of the diffraction peak of the powder X-ray diffraction measurement becomes high, as well as the half-value width thereof becomes narrowed.

The details of the measurement method are shown in Examples.

Further, in the powder X-ray diffraction measurement, the glass-ceramic solid electrolyte has no peak B at a position of 2θ=23.6±1°, or has the peak B in the powder X-ray diffraction, when the glass-ceramic solid electrolyte has the peak B, a peak intensity ratio (I_{B}/I_{A}) of a peak intensity (I_{B}) of the peak B to a peak intensity (I_{A}) of the peak A is less than 0.05.

The peak A and the peak B are both diffraction peaks of the Li₄₋ₓGe₁₋ₓPₓS₄ system thio-LISICON region II type crystalline structure, or a crystalline structure similar to the thio-LISICON region II type.

The glass-ceramic solid electrolyte of the present aspect is characterized in that the peak A is observed at a high intensity, but the peak B is not observed or has a very low intensity. The present aspect has been made based on the finding that glass-ceramic solid electrolyte having such peaks has a filling rate equal or higher than that of a conventional glass-ceramic solid electrolyte, and a higher ionic conductivity.

The peak intensity ratio I_{B}/I_{A} is preferably 0.

In one embodiment, the glass-ceramic solid electrolyte exhibits diffraction peaks derived from lithium halide in powder X-ray diffraction measurement using CuKα ray. The lithium halide observed in the powder X-ray diffraction measurement of the glass-ceramic solid electrolyte has a crystallinity lower than that of lithium halide of the raw material. Since lithium halide itself is soft material, it can be considered that it has almost no effect of curing the glass-ceramic solid electrolyte of the present embodiment, even if the lithium halide has crystallinity to the degree that its peaks in powder X-ray diffraction measurement can be detected.

Further, in the glass-ceramic solid electrolyte of the present embodiment, the crystallite size calculated from the peak half-value width of the peak having the maximum intensity among the diffraction peaks derived from lithium halide is preferably 5 to 100 nm, and more preferably 10 to 90 nm.

The crystallite size can be adjusted by the composition or crystallization temperature. For example, the crystallite size can be adjusted by varying the molar ratio (Li/P) of the lithium (Li) to the phosphorus (P), the molar ratio (Br/X) of the bromine (Br) to the halogen (X), and the molar ratio (I/P) of the iodine (I) to the phosphorus (P). Further, the crystallite size can also be adjusted by the crystallization temperature since the crystallite size also becomes larger as increase of the crystallization temperature.

The peak half-value width is calculated from the XRD pattern. The details of the measurement method and calculation method are given in Examples.

The calculation target of the peak half-value width is, for example, the intensity of the diffraction peak of 2θ=45.0±1° in the case of the lithium halide being LiF, the intensity of the diffraction peak of 2θ=30.1±1° in the case of the lithium halide being LiCl, the intensity of the diffraction peak of 2θ=28±1° in the case of the lithium halide being LiBr, and the intensity of the diffraction peak of 2θ=25.5±1° in the case of the lithium halide being LiI.

Note that, the peak half-value width is calculated based on a peak of lithium halide of the type having a larger amount of the halogen among those added as a the raw materials in the production of the glass-ceramic solid electrolyte. If two lithium halides have equal in their molar ratio of the halogens, then the peak half-value width is calculated based on the peak of the lithium halide having the maximum intensity.

In one embodiment, a true density (g/cm³) of the glass-ceramic solid electrolyte is preferably 2.0 to 3.0 g/cm³. The true density being within the above range means that an amount of the PS₄³⁻ structure as the main skeleton and a total amount of halogen in the glass-ceramic solid electrolyte are within a certain range, so that the glass-ceramic solid electrolyte of the present disclosure can achieve high conductivity and high softness at the same time.

The true density of the glass-ceramic solid electrolyte of the present embodiment is more preferably 2.01 to 2.9 g/cm³, and particularly preferably 2.02 to 2.8 g/cm³.

The true density of the glass-ceramic solid electrolyte can be measured, for example, by a gas-phase displacement method using He gas. The method for measuring of the true density of the glass-ceramic solid electrolyte are shown in Examples.

In the glass-ceramic solid electrolyte of the present embodiment, the relative density of the glass-ceramic solid electrolyte is preferably 90% or more when made it to a green compact pressurized at 400 MPa (hereinafter referred to as a “400 MPa green compact”). The relative density may be 90.5% or more, and may be 91% or more. Usually, the relative density of the 400 MPa green compact is 99% or less.

In the present disclosure, the relative density of a 400 MPa green compact means a ratio of the density of pellets obtained by application of 400 MPa to compress the glass-ceramic solid electrolyte powder (referred to as pellet density), with respect to the true density of the glass-ceramic electrolyte (relative density=pellet density/true density). The higher relative density means a higher filling rate.

The details of the measurement method of the relative density of a 400 MPa green compact are described in Examples.

The ionic conductivity of the glass-ceramic solid electrolyte of the present embodiment can be 1 mS/cm or greater, and also can be 1.5 mS/cm or greater.

The method of measuring the ion conductivity is shown in Examples.

The glass-ceramic solid electrolyte of the present embodiment can be produced, for example, by mixing and grinding starting raw materials of a known lithium ionic sulfide solid electrolyte such that a molar ratio of constituent elements satisfies the predetermined range to obtain a vitrified material, and further by subjecting it to heat treatment.

As the starting raw materials for the glass-ceramic solid electrolyte of the present embodiment, two or more compounds containing lithium, phosphorus, sulfur, and a halogen (X) including at least bromine as constituent elements, or simple substances of the constituent elements can be used in combination, and any material capable of exhibiting ionic conductivity caused by the contained metal atoms can be employed without any particular limitation.

Examples of raw materials containing lithium (Li) include lithium compounds such as lithium sulfide (Li₂S), lithium oxide (Li₂O), lithium carbonate (Li₂CO₃), and lithium simple metal substance. Among them, lithium compounds are preferable, and lithium sulfide is more preferable.

The above-described lithium sulfide can be used without any particular limitation, but a lithium sulfide having a high purity is preferable. Lithium sulfide can be produced, for example, by the method described in JP-H07-330312 A, JP-H09-283156 A, JP 2010-163356 A, and JP 2011-84438 A.

Specifically, lithium hydroxide and hydrogen sulfide are reacted in a hydrocarbon-based organic solvent at 70° C. to 300° C. to form lithium hydrosulfide, and then, hydrogen sulfide is removed from this reaction solution to form lithium sulfide (JP 2010-163356 A).

Further, by reacting lithium hydroxide and hydrogen sulfide in an aqueous solvent at 10° C. to 100° C. to form lithium hydrosulfide, and then hydrogen sulfide is removed from this reaction liquid to form lithium sulfide (JP 2011-84438 A).

Examples of raw materials containing phosphorus (P) include phosphorus sulfides such as diphosphorus trisulfide (P₂S₃), and diphosphorus pentasulfide (P₂S₅); phosphorus compounds such as sodium phosphate (Na₃PO₄); and phosphorus simple compound. Of these, phosphorus sulfides are preferred, and diphosphorus pentasulfide (P₂S₅) is more preferred. Phosphorus compounds such as diphosphorus pentasulfide (P₂S₅) and phosphorus simple compound can be used without any particular limitation as long as they are industrially manufactured and sold.

The raw material containing halogen (X) as a constituent element preferably contains halogen compounds represented by, for example, the following formula.

Mᵣ-Xₘ

In the formula, M represents an element such as sodium (Na), lithium (Li), boron (B), aluminum (Al), silicon (Si), phosphorus (P), sulfur(S), germanium (Ge), arsenic (As), selenium (Se), tin (Sn), antimony (Sb), tellurium (Te), lead (Pb), or bismuth (Bi); or a group formed by bonding an oxygen element or sulfur element to these elements. Lithium (Li) or phosphorus (P) is preferred, and lithium (Li) is more preferred.

X is a halogen element selected from fluorine (F), chlorine (CI), bromine (Br), and iodine (I).

In addition, I is an integer of 1 or 2, and m is an integer of 1 to 10. When m is an integer of 2 to 10, that is, when a plurality of Xs are present, Xs may be the same or different. For example, in SiBrCl₃ described later, m is 4, and Xs are composed of different elements of Br and Cl.

Specific examples of the halogen compound represented by the above formula include sodium halides such as NaI, NaF, NaCl, and NaBr; lithium halides such as LiF, LiCl, LiBr, and LiI; boron halides such as BCl₃, BBr₃, and BI₃; aluminum halides such as AlF₃, AlBr₃, AlI₃, and AlCl₃; silicon halides such as SiF₄, SiCl₄, SiCl₃, Si₂Cl₆, SiBr₄, SiBrCl₃, SiBr₂Cl₂, and SiI₄; phosphorus halides such as PF₃, PF₅, PCl₃, PCl₃, POCl₃, PBr₃, POBr₃, PI₃, P₂Cl₄, and P₂I₄; sulfur halides such as SF₂, SF₄, SF₆, S₂F₁₀, SCl₂, S₂Cl₂, and S₂Br₂; germanium halides such as GeF₄, GeCl₄, GeBr₄, GeI₄, GeF₂, GeCl₂, GeBr₂, and GeI₂; arsenic halides such as AsF₃, AsCl₃, AsBr₃, Asl₃, and AsF₅; selenium halides such as SeF₄, SeF₆, SeCl₂, SeCl₄, Se₂Br₂, and Se₂Br₂; tin halides such as SnF₄, SnCl₄, SnBr₄, SnI₄, SnF₂, SnCl₂, SnBr₂, and SnI₂; antimony halides such as SbF₃, SbCl₃, SbBr₃, SbI₃, SbF₅, and SbCl₅; tellurium halides such as TeF₄, Te₂F₁₀, TeF₅, TeCl₂, TeCl₄, TeBr₂, TeBr₄, and TeI₄; lead halides such as PbF₄, PbCl₄, PbF₂, PbCl₂, PbBr₂, and PbI₂; and bismuth halides such as BiF₃, BiCl₃, BiBr₃, and BiI₃.

Among them, preferred examples thereof include lithium halides such as lithium chloride (LiCl), lithium bromide (LiBr), and lithium iodide (LiI); and phosphorus halides such as phosphorus pentachloride (PCl₅), phosphorus trichloride (PCl₃), phosphorus pentabromide (PBr₅), and phosphorus tribromide (PBr₃). Among these, lithium halides such as LiCl, LiBr, and LiI; and PBr₃ are preferable, and lithium halides such as LiCl, LiBr, and LiI are more preferable, and LiI and LiBr are more preferable.

As the halogen compound, the compound described above may be used alone or in combination of two or more kinds. That is, at least one of the above compounds may be used.

In the present embodiment, the raw materials preferably contain a lithium compound, a phosphorus compound and one or two or more kinds of halogen compounds, and at least one of the lithium compound and phosphorus compound contain sulfur element, more preferably in combination of lithium sulfide, phosphorus sulfide and two or more lithium halides, and still more preferably in combination of lithium sulfide, diphosphorus pentasulfide and two or more kinds of lithium halides.

For example, when lithium sulfide, diphosphorus pentasulfide and two or more kinds of lithium halides are used as the raw materials of the glass-ceramic solid electrolyte of the present disclosure, the molar ratio of lithium sulfide to diphosphorus pentasulfide in molar ratios of the charged raw materials is preferably 65 to 85:15 to 35, more preferably 70 to 80:20 to 30, still more preferably 72 to 78:22 to 28, and particularly preferably 75:25.

When the amount of substance of Li₃PS₄ calculated from the constituent elements Li, P and S of lithium sulfide and diphosphorus pentasulfide is set to 100 parts by mole, the amount of lithium halide is preferably 10 to 250 parts by mole, more preferably 50 to 225 parts by mole, and may be 70 to 200 parts by mole.

In the present embodiment, the raw material is reacted by applying mechanical stress to form an intermediate (glassy powder). Herein, “applying mechanical stress” is mechanical application of shear stress, impact force, or the like. Means for application of mechanical stress includes, for example, use of pulverizers such as a planetary ball mill, a vibration mill, or a rolling mill; and a kneader. The raw materials are ground and mixed with strong mechanical stress, until at least a part thereof cannot maintain the crystallinity.

As the conditions of grinding and mixing, for example, when using a planetary ball mill as a pulverizer, treatment may be carried out at a rotational speed of several tens to several hundreds revolutions per minute for 0.5 hours to 100 hours. More specifically, in the case of using the planetary ball mill (manufactured by Fritsch: Model No. P-5) used in Examples, treatment may be carried out at a rotational speed of preferably 100 rpm or more and 400 rpm or less, and more preferably 150 rpm or more and 300 rpm or less.

When, for example, balls made of zirconia are used as the pulverization media, its diameter is preferably 0.2 to 20 mm.

The temperature at the time of grinding is not particularly specified, but is preferably 200° C. or lower in order to prevent the solid electrolyte itself from crystallizing and hardening.

The intermediate prepared by grinding and mixing is heat-treated. Specifically, the heating temperature of the intermediate is preferably set to a range of 5° C. or lower, more preferably 10° C. or lower, still more preferably 15° C. or lower, from the peak top temperature (T_{c1}) of the exothermic peak observed at the lowest temperature side when the intermediate is subjected to simultaneous thermogravimetry/differential thermal analysis (TGDTA) using a simultaneous thermogravimetry/differential thermal analyzer (TGDTA device) at a temperature increasing rate of 10° C./min. The lower limit is not particularly limited but may be set to be a range of about −10° C. or higher from the peak top temperature of the exothermic peak observed at the lowest temperature side. By setting the temperature within this range, the glass-ceramic solid electrolyte of the present embodiment can be obtained more efficiently.

The heating temperature for obtaining the glass-ceramic solid electrolyte of the present embodiment cannot be generally defined, but is usually preferably 250° C. or lower, more preferably 225° C. or lower, and still more preferably 200° C. or lower. The lower limit is not particularly limited, but is preferably 100° C. or higher, more preferably 110° C. or higher, and still more preferably 120° C. or higher.

The heating time is not particularly limited as long as the desired glass-ceramic solid electrolyte is obtained, but is preferably, for example, 10 minutes or more, more preferably 30 minutes or more, still more preferably 60 minutes or more, and still more preferably 2 hours or more. The upper limit of the heating time is not particularly limited, but is preferably 10 hours or less, more preferably 8 hours or less, still more preferably 6 hours or less, and still more preferably 4 hours or less.

The atmosphere during the heat treatment is not particularly limited, and may be under a flow of hydrogen sulfide gas, under an inert gas atmosphere such as nitrogen or argon, or under vacuum atmosphere.

The glass-ceramic solid electrolyte of the present embodiment is preferably used in a battery because it has a filling rate higher than a conventional glass-ceramic solid electrolyte, and a higher ionic conductivity. It is particularly suitable when lithium element is used as the conductive species. The glass-ceramic solid electrolyte of the present embodiment may be used for a positive electrode layer, a negative electrode layer, or an electrolyte layer.

A lithium-ion battery according to one aspect of the present disclosure contains the glass-ceramic solid electrolyte of the present disclosure described above. For example, an all-solid lithium-ion battery can be produced by using the glass-ceramic solid electrolyte of the present disclosure instead of a liquid-based electrolyte.

An all-solid lithium-ion battery is mainly composed of a positive electrode layer, a negative electrode layer, and an electrolyte layer, but the glass-ceramic solid electrolyte of the present disclosure can be used in any of these layers. Note that each layer can be produced by a known method.

For example, when the glass-ceramic solid electrolyte of the present disclosure is used in a positive electrode layer and a negative electrode layer, a positive electrode active material or a negative electrode active material is mixed and dispersed therein to obtain a positive electrode mixture or a negative electrode mixture.

The positive electrode active material is not particularly limited as long as the positive electrode active material can accelerate a cell chemical reaction accompanied by the migration of lithium ions caused by lithium element, which is preferably employed as an element for expressing ion conductivity in the present embodiment, in relation to the negative electrode active material. Examples of the positive electrode active material capable of intercalating and deintercalating lithium ions include an oxide-based positive electrode active material and a sulfide-based positive electrode active material.

Preferred examples of the oxide-based positive electrode active material include LMO (lithium manganese), LCO (lithium cobaltate), NMC (lithium nickel manganese cobalt oxide), NCA (lithium nickel cobalt aluminate), LNCO (lithium nickel cobalt oxide), and transition metal complex oxides containing lithium such as olivine-type compounds (LiMeNPO₄, Me═Fe, Co, Ni, Mn).

Examples of the sulfide-based positive electrode active material include titanium sulfide (TiS₂), molybdenum sulfide (MoS₂), iron sulfide (FeS, FeS₂), copper sulfide (CuS), nickel sulfide (Ni₃S₂), and the like.

In addition to the above-mentioned positive electrode active material, niobium selenide (NbSe₃) or the like can also be used.

In the present embodiment, the positive electrode active material may be used alone or in combination of a plurality of types.

As the negative electrode active material, substances can be used without any particular limitation as long as it can accelerate a battery chemical reaction accompanied by the migration of lithium ions, preferably caused by a lithium element, such as an element preferably employed as an element for expressing ionic conductivity in the present embodiment, preferably a metal capable of forming an alloy with a lithium element, an oxide thereof, and an alloy of the metal and a lithium element. As such negative electrode active materials capable of intercalating and deintercalating lithium ions, known materials in the field of a battery as a negative electrode active material can be employed without limitation.

Examples of such negative electrode active materials include metal simple substances such as metal lithium, metal indium, metal aluminum, metal silicon, and metal tin; metals capable of forming an alloy with metal lithium; oxides of these metals; and alloys of these metals with metal lithium.

The electrode active material used in the present embodiment may be ones having a coating layer on which its surface is coated.

Examples of material for forming the coating layer preferably include an ionic conductor such as a nitride, an oxide, or a complex thereof of an element, preferably a lithium element, which exhibits an ionic conductivity in the crystallinity sulfide solid electrolyte used in the present embodiment. Specifically, examples thereof include a conductor having a LISICON type crystalline structure such as Li₄₋₂ₓZnₓGeO₄ having lithium nitride (Li₃N) or Li₄GeO₄ as a main structure, a conductor having a thio-LISICON type crystalline structure such as Li₄₋ₓGe₁₋ₓPₓS₄ having a Li₃PO₄ type skeleton structure, a conductor having a perovskite type crystalline structure such as La_{2/3-x}Li₃ₓTiO₃, and a conductor having a NASICON type crystalline structure such as LiTi₂(PO₄)₃.

In addition, examples thereof include lithium titanate such as Li_{y}Ti_{3-y}O₄ (0<y<3) and Li₄Ti₅O₁₂ (LTO), lithium metalates composed of a metal belonging to Group 5 of the periodic table, such as LiNbO₃ and LiTaO₃, and oxide-based conductors such as Li₂O—B₂O₃—P₂O₅ type, Li₂O—B₂O₃—ZnO type, and Li₂O—Al₂O₃—SiO₂—P₂O₅—TiO₂ type.

The electrode active material having a coating layer is obtained, for example, by adhering a solution containing various elements constituting the material forming the coating layer on the surface of the electrode active material, and by firing the electrode active material after the adhesion at preferably 200° C. or higher and 400° C. or lower.

Here, as the solution containing various elements, for example, a solution containing a metal alkoxide of various metals such as lithium ethoxide, titanium isopropoxide, niobium isopropoxide, and tantalum isopropoxide may be used. In the case of using the solution of a metal alkoxide, as the solvent, an alcohol-based solvent such as ethanol or butanol, an aliphatic hydrocarbon solvent such as hexane, heptane, or octane; an aromatic hydrocarbon solvent such as benzene, toluene, or xylene may be used.

The above-described adhesion may also be performed by immersion in the solution, spray coating with the solution, or the like.

The firing temperature is preferably 200° C. or higher and 400° C. or lower, and more preferably 250° C. or higher and 390° C. or lower, and the firing time is usually about 1 minute to 10 hours, and preferably 10 minutes to 4 hours, from the viewpoint of increasing the production efficiency and the battery performance.

The coverage rate of the coating layer is preferably 90% or more, more preferably 95% or more, and still more preferably 100%, that is, the entire surface is coated, on the basis of the surface area of the electrode active material. The thickness of the coating layer is preferably 1 nm or more, and more preferably 2 nm or more, and the upper limit is preferably 30 nm or less, and more preferably 25 nm or less.

The thickness of the coating layer can be measured by cross-sectional observation using the transmission electrons microscopy (TEM), and the coverage rate can be calculated from the thickness of the coating layer, elemental analysis value, and BET surface area.

The above-mentioned battery preferably uses a current collector in addition to the positive electrode layer, the electrolyte layer, and the negative electrode layer. As the current collector, known current collectors can be used. As examples of the current collectors, a layer of a material that reacts with the above-mentioned glass-ceramic solid electrolyte, such as Au, Pt, Al, Ti or Cu, coated with Au or the like can be used.

### Examples

The present disclosure is specifically described by reference to Examples. The present disclosure is not limited to Examples. The methods for evaluating samples prepared in the respective Examples are as follows:

### (1) Powder X-Ray Diffraction (XRD) Measurement

The glass solid electrolyte powders prepared in the respective Examples were filled into a groove with a diameter of 20 mm and a depth of 0.2 mm, and the excess powder was scraped off with a glass. The filled samples were measured without being exposed to the atmosphere by the use of a Kapton film for XRD. The 2θ position of a diffraction peak was determined by Le Bail analysis using an XRD analysis program RIETAN-FP.

The powder X-ray diffraction measurement was performed under the following conditions.
Equipment used: “D2 PHASER” manufactured by BRUKER
Tube voltage: 30 kV
Tube current: 10 mA
X-ray wavelength: Cu-Kα ray (1.5418 Å)
Optical system: Convergence method
Slit configuration: Solar slit 4°, Divergence slit 1 mm, Kβ filter (Ni plate) is used
Detector: Semiconductor detector
Measuring range: 2θ=10 to 60° (deg)
Step-width, Scanning speed: 0.05°, 0.05°/sec

In the analysis of a peak position to ascertain the presence of a crystalline structure on the basis of a measurement result, the XRD analytic program RIETAN-FP was used, a base line was corrected by 11th-degree Legendre orthogonal polynomials, and a peak position was found.

### (2) Peak Half-Value Width

As an example, a method for calculating a peak half-value width of a peak in the range of 2θ=20±1° is shown below. The calculation is performed at a peak of 2θ=25.5±1° in the case of LiI, and at a peak of 2θ=28±1° in the case of LiBr as to the lithium halide peak half-value width.

A half-value width E was determined such that the difference between the measured value of the intensity (vertical axis value of XRD pattern) and the calculated value below was minimized in the range (2θ=19 to) 21° in which the above-described peak exists.

The proportion of the Lorentz function is A (0≤A≤1), the intensity correction value is B, the angle of 2θ where the intensity is maximum is C, the angle of the intensity to be calculated (2θ) is D, the half-value width is E, and the background is F. Here, the background may be affected by an amorphous material, so that by using an uniform background O and a linear function P that changes according to the peak position, the background F may be calculated by the formula: F=O+P×D.

The measured value of the intensity at the angle of the intensity to be calculated (2θ) is G. A, B, C, E, O, and P are variables, and the gap H between the measured value of the intensity and the calculated value is calculated by the following formula (2) for each angle (2θ) at which the intensity is measured.

$$H = G - \{ B \times \{ A / ( 1 + 4 \times {( D - C )}^{2} / {E}^{2} ) + ( 1 - A ) \times exp ( - 1 \times {( D - C )}^{2} / {E}^{2} ) \times ( 4 ln ( 2 ) ) \} + O + P \times D \} \qquad ( 2 )$$

The above variables including the half-value width E were determined by summing H's in the range of 2θ=19 to 21°, and minimizing the sum of H's in a GRG non-linear manner using the solver function of spreadsheet software Excel (Microsoft).

### (3) The Crystallite Size

In order to compensate the spread of the half-value width due to the device used, the half-value width E calculated as above was corrected with NIST standard Si (640d, crystallite diameter: 525 nm). When the half-value width as corrected is taken as a B_{correct}, the corrected half-value width β for calculating the crystallite size can be expressed by the following formula.

$$β = b - {B}_{correct}$$

The actual crystallite size L was calculated by the following formula:

$$L = K \times λ ( βcos ( C / 2 ) )$$

Wherein the constant K is 0.9, and λ is the wavelength of the X-ray used for the measurement. Note that, C is the angle (2θ) of the central position of the maximum peak used in the calculation of the peak half-width.

### (4) Relative Density of 400 MPa Green Compact

### (Measurement of True Density)

The true density was measured by a gas phase displacement method using He gas (BELMAX, manufactured by Microtracbell). The internal volumes of the cell were calculated at the He gases pressure of 55 KPa, 60 KPa, 65 KPa, 70 KPa, 75 KPa, 80 KPa, 85 KPa, 90 KPa, 95 KPa, 100 KPa, 105 KPa and 110 KPa, respectively, and the average of these calculated volumes was taken as the cell internal volume. The cell weight was also calculated using an electronic balance. The capacity and weight of the blank cell were taken three times by the above-described method, the average value was set as the empty cell capacity V₁, and the weight is set as the empty cell weight W₁. The capacity of the gas phase portion in the cell and the total weight of the cell, when the glass solid electrolyte was charged in the cell were taken three times by the above-described method, and the average values thereof were taken as the volume V₂ excluding the sample, and as the total weight of the cell as W₂, respectively.

The true density d of the glass solid electrolyte can be calculated by the following formula:

$$d = ( {W}_{2} - {W}_{1} ) / ( {V}_{1} - {V}_{2} )$$

The true density of the sample was defined as the average value calculated three times by the above formula. The standard deviation of the true density calculated by this method is 0.05 g/cm³ or less.

### (Measurement of Pellet Density)

A schematic diagram of a pellet density measuring device is shown in FIG. 1.

The sample 10 was charged in a cylindrical jig 11 (manufactured by Makor (registered trademark)) and pressurized at a pressure of 400 MPa by a single-spindle pressing machine via a stainless-steel piston 12. The height of the sample (pellet) was measured from the difference between the length Lᵢₙₜ of the device in which the sample was not charged (blank) and the length Later of the device charged with the sample after pressurizing, and the pellet density dₚₑₗₗₑₜ was calculated therefrom.

Specifically, the piston 12 was inserted into the cylindrical jig 11 having a diameter of 10 mm (cross-sectional area Sₚₑₗₗₑₜ: 0.785 cm²) prior to input of a sample. The cylindrical jig 11 was rotated every 90° in a direction perpendicular to the pressing direction, the length of the device in which the sample was not charred (blank) was measured four times, and the average value thereof was defined as Lᵢₙₜ (cm). At this time, while applying pressure to the piston 12 by tightening the screw 13 and the nut 14 with a pressure of 8 N·m using a torque wrench, the length of the device in which the sample was not charged (blank) was measured.

Next, 0.3 g of the glass solid electrolyte powder as a sample was weighed by an electronic balance and charged into the cylindrical jig 11. After charging, the sample was pressure-molded by pressurizing the piston 12 with a single-spindle pressing machine. The pressure was maintained at 185 MPa for 2 minutes and then depressurized. The cell was rotated at 120° in the vertical direction from the pressing direction and pressed in the same manner. Then, it was rotated again 120° and pressed in the same manner. Next, the sample was pressurized at 400 MPa in the same manner as at a pressure of 185 MPa, using.

After molding, the length of the device charged with the sample after pressurizing was measured four times in the same manner as in Lᵢₙₜ, and the average value thereof was defined as L_{after} (cm). The pellet density dₚₑₗₗₑₜ was calculated by the following formula:

$${d}_{pellet} = 0.3 / \{ ( {L}_{after} - {L}_{int} ) \times {S}_{pellet} \}$$

### (Calculation of Relative Density)

The relative density was calculated by the following formula:

$$Relative density ( \% ) = pellet density \times 100 / true density$$

### (5) Ionic Conductivity

A circular pellet having a diameter of 10 mm (cross-sectional area S: 0.785 cm²) and a height (L) of 0.1 to 0.3 cm was formed of the glass-ceramic solid electrolyte prepared in respective Examples, and used it as a sample. The current collectors were attached to the top and bottom of the sample, and impedance spectra were measured at 25° C. (frequency range: 5 MHz to 0.5 Hz, amplitude: 10 mV) to obtain Cole-Cole plots. In the vicinity of the right end of the arc observed in the high-frequency region, the real part Z′ (Ω) at the point where-Z″ (Ω) is the smallest was taken as the bulk-resistance R (Ω) of the electrolyte, and the ionic conductivity σ (S/cm) was calculated by the following formula:

$$R = ρ ( L / S )$$

$$σ = 1 / ρ$$

### (6) Measurement of ICP

The solid electrolyte powders prepared in respective Examples were weighed and collected in a vial in an argon atmosphere. A KOH alkaline aqueous solution was placed in the vial, and the sample were appropriately diluted and dissolved while being careful not to collect sulfur content. The dissolved solutions were used as measurement solutions. This solution was subjected to measurement using a Paschen Runge type ICP-OES (SPECTRO ARCOS manufactured by SPECTRO), and the composition was determined.

Calibration solutions for Li, P and S were prepared by using a 1000 mg/L standard solution for ICP measurement, respectively. Calibration solutions for CI and Br were prepared by using a 1000 mg/L standard solution for ion chromatography, respectively.

Two measurement solutions were prepared for each sample, measurement was performed five times for each measurement solution, and the average value was calculated. The composition was determined by averaging the measured values of the two measurement solutions.

### Example 1

### [Preparation of Glass-Ceramic Solid Electrolyte]

Raw materials were weighed to be such that 2.319 g of lithium sulfide, 3.740 g of diphosphorus pentasulfide, and 3.941 g of lithium iodide were weighed, and 600 g of zirconia balls having a diameter of 10 mm were put into a 500 mL of zirconia pot together with the raw materials, and the pot was sealed. Table 1 shows the molar ratios of the starting raw materials.

Using a planetary ball mill (model number P-5, manufactured by Fritsch), an intermediate (glassy powder) was obtained by grinding treatment (mechanical milling) at room temperature at a rotational speed of 220 rpm for 40 hours.

About 2 g of the intermediate powder was held in vacuo at 155° C. for 2 hours, then slowly cooled to obtain a glass-ceramic solid electrolyte.

Note that, the peak top temperature (T_{c1}) of the exothermic peak observed at the lowest temperature side when the intermediate is subjected to simultaneous thermogravimetry/differential thermal analysis (TGDTA) using a simultaneous thermogravimetry/differential thermal analyzer (TGDTA device) at a temperature increasing rate of 10° C./min, was 170° C.

The ionic conductivity (σ) of the obtained glass-ceramic solid electrolyte was 3.8 mS/cm. The XRD pattern of the glass-ceramic solid electrolyte is shown in FIG. 1.

### Examples 2 to 21, and Comparative Examples 1 to 11

Glass-ceramic solid electrolytes were prepared and evaluated in the same manner as in Example 1 except that the raw material composition ratios and the heating temperature of the intermediate were changed as shown in Table 1. The results are shown in Table 1 and Table 2.

In Table 1, the amount of substance of Li₃PS₄ was 100 parts by mole, and this corresponds to 150 parts by mole of Li₂S and 50 parts by mole of P₂S₅ as a starting raw material.

In Examples 2 to 21 and Comparative Examples 1, 4 to 7, and 9 to 11, the heating temperature was set at 15° C. or lower than the peak-top temperature (T_{c1}) of the exothermic peak observed on the lowest temperature side in the simultaneous thermogravimetry/differential thermal analysis (TGDTA), and it was set at a temperature same as T_{c1} in Comparative Examples 2, and it was set at a temperature higher than Ter in Comparative Examples 3 and 8.

In Examples 2, 17, 19 and Comparative Examples 5 and 8, the molar ratio (X/P) of the respective elements to the phosphorus (P) of the glass-ceramic solid electrolyte was measured by ICP.

The results are indicated below.
Example 2: Li/P=3.95, S/P=3.96, Br/P=0, I/P=1.03
Example 17: Li/P=3.95, S/P=3.95, Br/P=0.53, I/P=0.52
Example 19: Li/P=3.95, S/P=3.95, Br/P=1.04, I/P=0
Comparative Example 5: Li/P=3.55, S/P=4.01, Br/P=0.27, I/P=0.27
Comparative Example 8: Li/P=3.94, S/P=3.95, Br/P=0, I/P=1.03

TABLE 1

| | | | | | | | | | | Glass Ceramic Solid Electrolyte | | |
|---|---|---|---|---|---|---|---|---|---|---|---|---|
| | Molar Ratio of | | | Molar Ratio Relative to | | | | | Heating | Peak | | |
| | Raw Materials | | | Phosphorus | | | | | Temperature | Position and Intensity | | |
| | Li₃PS₄ | LiBr | Lil | Li/P | S/P | Br/P | I/P | X/P | (° C.) | I_{A} | 2θ(I_{A}) | I_{B} |
| Example 1 | 100 | 0 | 87.5 | 3.88 | 4.00 | 0.00 | 0.88 | 0.88 | 155 | 3427 | 20.47 | 0 |
| Example 2 | 100 | 0 | 100 | 4.00 | 4.00 | 0.00 | 1.00 | 1.00 | 155 | 4433 | 20.31 | 0 |
| Example 3 | 100 | 0 | 125 | 4.25 | 4.00 | 0.00 | 1.25 | 1.25 | 155 | 5594 | 20.66 | 0 |
| Example 4 | 100 | 0 | 150 | 4.50 | 4.00 | 0.00 | 1.50 | 1.50 | 133 | 12181 | 20.90 | 0 |
| Example 5 | 100 | 12.5 | 75 | 3.88 | 4.00 | 0.13 | 0.75 | 0.88 | 155 | 4361 | 20.27 | 0 |
| Example 6 | 100 | 12.5 | 100 | 4.13 | 4.00 | 0.13 | 1.00 | 1.13 | 150 | 3980 | 20.38 | 0 |
| Example 7 | 100 | 12.5 | 125 | 4.38 | 4.00 | 0.13 | 1.25 | 1.38 | 145 | 5742 | 20.88 | 0 |
| Example 8 | 100 | 12.5 | 150 | 4.63 | 4.00 | 0.13 | 1.50 | 1.63 | 150 | 5401 | 20.90 | 0 |
| Example 9 | 100 | 25 | 75 | 4.00 | 4.00 | 0.25 | 0.75 | 1.00 | 153 | 7002 | 20.27 | 0 |
| Example 10 | 100 | 25 | 100 | 4.25 | 4.00 | 0.25 | 1.00 | 1.25 | 146 | 4705 | 20.57 | 0 |
| Example 11 | 100 | 25 | 125 | 4.50 | 4.00 | 0.25 | 1.25 | 1.50 | 144 | 6241 | 20.91 | 0 |
| Example 12 | 100 | 25 | 150 | 4.75 | 4.00 | 0.25 | 1.50 | 1.75 | 146 | 4634 | 20.93 | 0 |
| Example 13 | 100 | 37.5 | 75 | 4.13 | 4.00 | 0.38 | 0.75 | 1.13 | 149 | 5975 | 20.23 | 0 |
| Example 14 | 100 | 37.5 | 100 | 4.38 | 4.00 | 0.38 | 1.00 | 1.38 | 143 | 4569 | 20.60 | 0 |
| Example 15 | 100 | 37.5 | 125 | 4.63 | 4.00 | 0.38 | 1.25 | 1.63 | 141 | 5614 | 20.79 | 0 |
| Example 16 | 100 | 37.5 | 150 | 4.88 | 4.00 | 0.38 | 1.50 | 1.88 | 145 | 4843 | 20.91 | 0 |
| Example 17 | 100 | 50 | 50 | 4.00 | 4.00 | 0.50 | 0.50 | 1.00 | 152 | 5563 | 20.15 | 0 |
| Example 18 | 100 | 50 | 100 | 4.50 | 4.00 | 0.50 | 1.00 | 1.50 | 130 | 7702 | 20.63 | 0 |
| Example 19 | 100 | 100 | 0 | 4.00 | 4.00 | 1.00 | 0.00 | 1.00 | 181 | 3204 | 20.22 | 0 |
| Example 20 | 100 | 100 | 50 | 4.50 | 4.00 | 1.00 | 0.50 | 1.50 | 148 | 5549 | 20.23 | 0 |
| Example 21 | 100 | 100 | 100 | 5.00 | 4.00 | 1.00 | 1.00 | 2.00 | 119 | 4427 | 20.63 | 0 |
| Comparative | 100 | 37.5 | 25 | 3.63 | 4.00 | 0.38 | 0.25 | 0.63 | 172 | 6938 | 20.10 | 901 |
| Example 1 | | | | | | | | | | | | |
| Comparative | 100 | 37.5 | 25 | 3.63 | 4.00 | 0.38 | 0.25 | 0.63 | 187 | 8631 | 20.13 | 1511 |
| Example 2 | | | | | | | | | | | | |
| Comparative | 100 | 37.5 | 25 | 3.63 | 4.00 | 0.38 | 0.25 | 0.63 | 200 | 9409 | 20.08 | 1748 |
| Example 3 | | | | | | | | | | | | |
| Comparative | 100 | 50 | 0 | 3.50 | 4.00 | 0.50 | 0.00 | 0.50 | 184 | 4001 | 20.25 | 336 |
| Example 4 | | | | | | | | | | | | |
| Comparative | 100 | 25 | 25 | 3.50 | 4.00 | 0.25 | 0.25 | 0.50 | 175 | 9260 | 20.07 | 1708 |
| Example 5 | | | | | | | | | | | | |
| Comparative | 100 | 0 | 50 | 3.50 | 4.00 | 0.00 | 0.50 | 0.50 | 178 | 6199 | 20.00 | 1322 |
| Example 6 | | | | | | | | | | | | |
| Comparative | 100 | 0 | 75 | 3.75 | 4.00 | 0.00 | 0.75 | 0.75 | 159 | 6843 | 20.18 | 349 |
| Example 7 | | | | | | | | | | | | |
| Comparative | 100 | 0 | 100 | 4.00 | 4.00 | 0.00 | 1.00 | 1.00 | 180 | 4616 | 21.20 | 0 |
| Example 8 | | | | | | | | | | | | |
| Comparative | 100 | 150 | 0 | 4.50 | 4.00 | 1.50 | 0.00 | 1.50 | 181 | 3227 | 20.26 | 0 |
| Example 9 | | | | | | | | | | | | |
| Comparative | 100 | 12.5 | 175 | 4.88 | 4.00 | 0.13 | 1.75 | 1.88 | 152 | 4901 | 21.20 | 0 |
| Example 10 | | | | | | | | | | | | |
| Comparative | 100 | 37.5 | 175 | 5.13 | 4.00 | 0.38 | 1.75 | 2.13 | 145 | 4669 | 21.30 | 0 |
| Example 11 | | | | | | | | | | | | |

| | Glass Ceramic Solid Electrolyte | | | | | | | |
|---|---|---|---|---|---|---|---|---|
| | Peak | | Crystallite Size | | Ionic | Pellet | True | Filling |
| | Intensity Ratio | Crystallite | of LiX (nm) | | Conductivity | Density | Density | Rate |
| | I_{B}/I_{A} | Size (nm) | X = Br | X = I | (mS/cm) | (g/cm³) | (g/cm³) | (%) |
| Example 1 | 0.00 | 5.34 | — | 88.20 | 3.82 | 2.23 | — | — |
| Example 2 | 0.00 | 6.56 | — | 33.51 | 3.59 | 2.36 | 2.45 | 96.24 |
| Example 3 | 0.00 | 5.38 | — | 22.90 | 2.23 | 2.52 | — | — |
| Example 4 | 0.00 | 18.33 | — | 20.38 | 1.83 | 2.48 | 2.74 | 90.51 |
| Example 5 | 0.00 | 7.15 | — | 67.64 | 4.51 | 2.17 | — | — |
| Example 6 | 0.00 | 6.85 | — | 33.30 | 3.75 | 2.20 | — | — |
| Example 7 | 0.00 | 5.44 | — | 20.58 | 2.34 | 2.46 | — | — |
| Example 8 | 0.00 | 6.00 | — | 18.59 | 1.81 | 2.51 | — | — |
| Example 9 | 0.00 | 7.42 | — | 64.24 | 4.38 | 2.21 | 2.39 | 92.60 |
| Example 10 | 0.00 | 5.62 | — | 35.21 | 3.09 | 2.22 | — | — |
| Example 11 | 0.00 | 5.48 | — | 18.63 | 2.22 | 2.37 | 2.60 | 91.11 |
| Example 12 | 0.00 | 5.44 | — | 17.10 | 1.74 | 2.38 | — | — |
| Example 13 | 0.00 | 8.04 | — | 54.41 | 4,50 | 2.15 | — | — |
| Example 14 | 0.00 | 7.94 | — | 38.37 | 2.20 | 2.34 | — | — |
| Example 15 | 0.00 | 10.60 | — | 14.64 | 1.47 | 2.53 | — | — |
| Example 16 | 0.00 | 6.34 | — | 14.69 | 1.76 | 2.28 | — | — |
| Example 17 | 0.00 | 10.75 | — | 37.71 | 4.08 | 2.21 | 2.41 | 91.65 |
| Example 18 | 0.00 | 16.18 | — | 32.57 | 1.14 | 2.35 | 2.50 | 94.00 |
| Example 19 | 0.00 | 6.36 | 14.42 | — | 1.47 | 1.99 | 2.04 | 97.59 |
| Example 20 | 0.00 | 5.48 | 16.43 | — | 2.78 | 2.38 | 2.52 | 94.44 |
| Example 21 | 0.00 | 8.88 | — | 30.22 | 1.04 | 2.45 | 2.60 | 94.23 |
| Comparative | 0.13 | 14.60 | — | — | 4.17 | 2.02 | — | — |
| Example 1 | | | | | | | | |
| Comparative | 0.18 | 17.65 | — | — | 5.88 | 1.99 | — | — |
| Example 2 | | | | | | | | |
| Comparative | 0.19 | 20.45 | — | — | 6.56 | 1.99 | — | — |
| Example 3 | | | | | | | | |
| Comparative | 0.08 | 12.66 | — | — | 2.66 | 1.82 | 2.09 | 86.98 |
| Example 4 | | | | | | | | |
| Comparative | 0.18 | 16.57 | — | — | 4.73 | 1.94 | 2.19 | 88.51 |
| Example 5 | | | | | | | | |
| Comparative | 0.21 | 15.26 | — | — | 4.66 | 2.00 | 2.25 | 89.09 |
| Example 6 | | | | | | | | |
| Comparative | 0.05 | 7.16 | — | 68.91 | 4.47 | 2.13 | — | — |
| Example 7 | | | | | | | | |
| Comparative | 0.00 | 12.90 | — | 35.68 | 1.76 | 2.13 | 2.45 | 86.86 |
| Example 8 | | | | | | | | |
| Comparative | 0.00 | 4.10 | 15.16 | — | 0.90 | 1.92 | 2.39 | 80.33 |
| Example 9 | | | | | | | | |
| Comparative | 0.00 | 7.89 | — | 18.48 | 1.61 | 2.44 | — | — |
| Example 10 | | | | | | | | |
| Comparative | 0.00 | 6.11 | — | 15.71 | 1.53 | 2.75 | — | — |
| Example 11 | | | | | | | | |

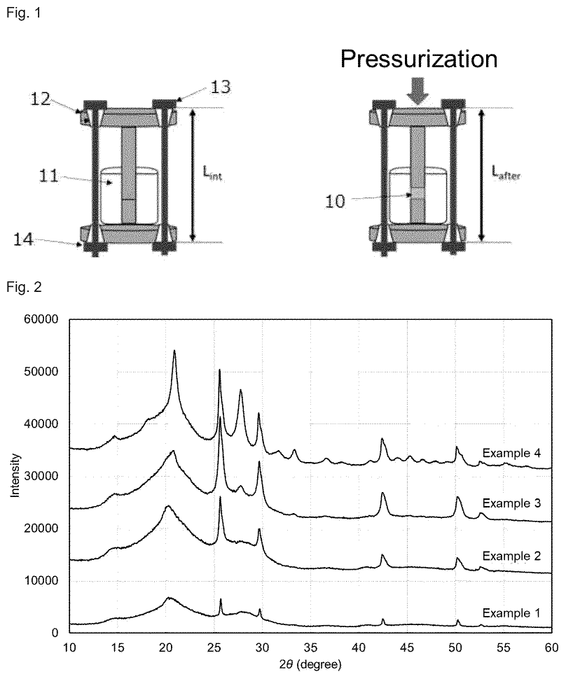

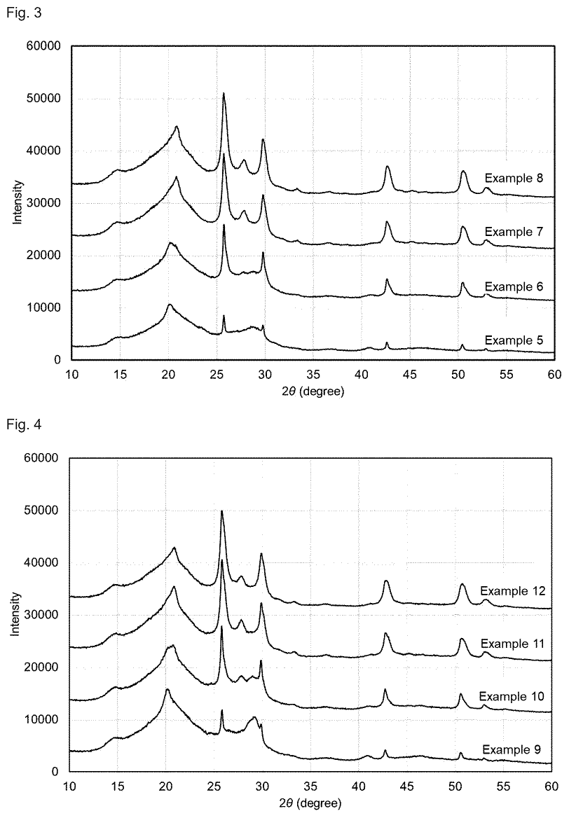

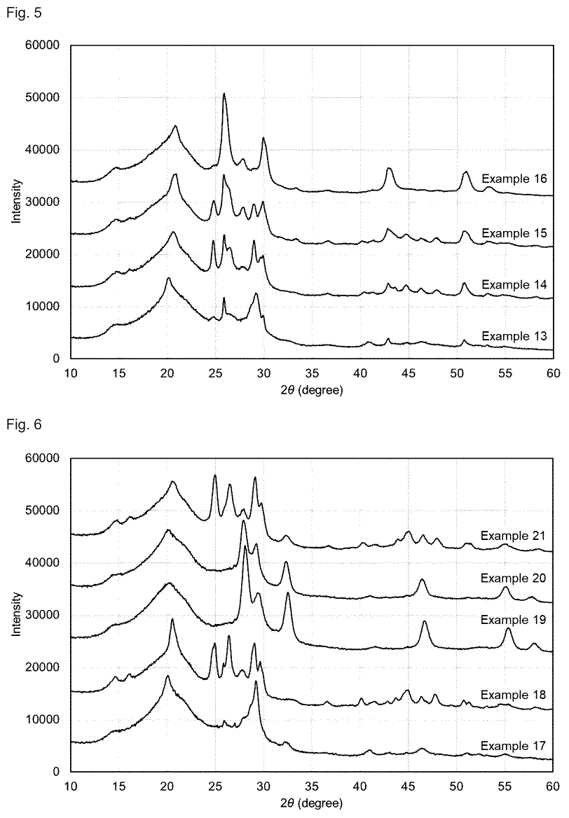

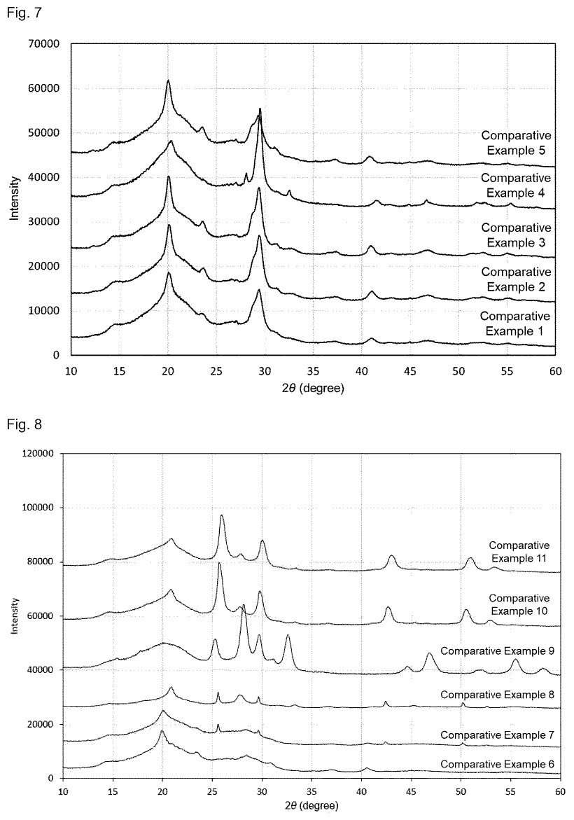

FIG. 2 shows X-ray diffraction patterns of the glass-ceramic solid electrolytes prepared in Examples 1 to 4. FIG. 3 shows X-ray diffraction patterns of the glass-ceramic solid electrolytes prepared in Examples 5 to 8. FIG. 4 shows X-ray diffraction patterns of the glass-ceramic solid electrolytes prepared in Examples 9 to 12. FIG. 5 shows X-ray diffraction patterns of the glass-ceramic solid electrolytes prepared in Examples 13 to 16. FIG. 6 shows X-ray diffraction patterns of the glass-ceramic solid electrolytes prepared in Examples 17 to 21. FIG. 7 shows X-ray diffraction patterns of the glass-ceramic solid electrolytes prepared in Comparative Examples 1 to 5. FIG. 8 shows X-ray diffraction patterns of the glass-ceramic solid electrolytes prepared in Comparative Examples 6 to 11.

In the X-ray diffraction patterns obtained in Examples, since an XRD spectra indicating low crystallinity were obtained, the destruction of the crystallite can be prevented when the glass-ceramic solid electrolyte is compressed. As a result, high ionic conductivity can be maintained and voids between large crystallites can be prevented to generate, so that the filling rate can also be maintained high. In addition, from the fact that lithium halide gives a glass-ceramic solid electrolyte having an XRD spectrum indicating low crystallinity, it is not considered that lithium halide has a curing effect on the glass-ceramic solid electrolyte.

### INDUSTRIAL APPLICABILITY

The glass-ceramic solid electrolyte of the present disclosure is suitable as a lithium-ion battery constituent material. In addition, the lithium-ion battery of the present disclosure is suitably used for information related devices such as a personal computer, a video camera, and a mobile phone, communication devices, battery used in vehicle such as electric vehicle, and the like.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A glass-ceramic solid electrolyte comprising lithium, phosphorus, sulfur and halogen as constituent elements, wherein
a molar ratio (Li/P) of the lithium (Li) to the phosphorus (P) is 2.0 to 5.3,
a molar ratio (S/P) of the sulfur(S) to the phosphorus (P) is 2.0 to 4.5, and
a molar ratio (X/P) of the halogen (X) to the phosphorus (P) is 0.1 to 2.3, and
the glass-ceramic solid electrolyte has a peak A at position of 2θ=20±1° in powder X-ray diffraction using CuKα ray, and has no peak B at a position of 2θ=23.6±1°, or has the peak B in the powder X-ray diffraction,
when the glass-ceramic solid electrolyte has the peak B, a peak intensity ratio (I_{B}/I_{A}) of a peak intensity (I_{B}) of the peak B to a peak intensity (I_{A}) of the peak A is less than 0.050, and
the glass-ceramic solid electrolyte has a crystallite size of 5 to 20 nm.

2. The glass-ceramic solid electrolyte according to claim 1, wherein the peak intensity ratio (I_{B}/I_{A}) is 0.

3. The glass-ceramic solid electrolyte according to claim 1, which has peaks derived from lithium halide in the powder X-ray diffraction using CuKα ray.

4. The glass-ceramic solid electrolyte according to claim 3, wherein a crystallite size of the lithium halide calculated from a peak having the maximum intensity among the peaks derived from the lithium halide is 5 to 100 nm.

5. The glass-ceramic solid electrolyte according to claim 1, wherein a relative density of a green compact pressurized at 400 MPa has 90% or more.

6. The glass-ceramic solid electrolyte according to claim 1, having a true density of 2.0 to 3.0 g/cm³.

7. The glass-ceramic solid electrolyte according to claim 1, wherein the molar ratio (X/P) is greater than 0.86.

8. The glass-ceramic solid electrolyte according to claim 1, comprising two or more halogens as the halogen.

9. The glass-ceramic solid electrolyte according to claim 8, wherein the halogen comprises iodine and bromine.

10. The glass-ceramic solid electrolyte according to claim 9, wherein
a molar ratio (I/P) of the iodine (I) to the phosphorus (P) is 0.0<(I/P)<1.8, and
a molar ratio (Br/P) of the bromine (Br) to the phosphorus (P) is 0.0<(Br/P)<1.5.

11. The glass-ceramic solid electrolyte according to claim 1, having an ionic conductivity of 1 mS/cm or more.

12. A lithium-ion battery comprising the glass-ceramic solid electrolyte according to claim 1.
